(19) United States
(12) Patent Application Publication
(10) Pub. No.: US 2026/0338660 A1
(43) Pub. Date: Oct. 29, 2026

(54) METHOD FOR CARRYING OUT A FILTER TEST, AND STERILE FILTER SET WITH INSTRUCTIONS FOR CARRYING OUT SUCH A METHOD

(71) Applicant: VETTER PHARMA-FERTIGUNG GMBH & CO. KG, Ravensburg (DE)

(72) Inventors: Frank BÖTTGER, Bergatreute (DE); Benjamin BÖBST, Ostrach (DE); Dennis SCHMIDT, Friedrichshafen (DE)

(21) Appl. No.: 18/997,354

(22) PCT Filed: Aug. 3, 2023
(86) PCT No.: PCT/EP2023/071608

§ 371 Date: Jan. 21, 2025

(30) Foreign Application Priority Data
Aug. 8, 2022 (DE) 10 2022 119 936.3

(51) Int. Cl. G01N 15/08

(52) U.S. Cl. CPC G01N 15/0806; G01N 15/082; G01N 2015/084

(57) ABSTRACT

A method for carrying out a filter test, wherein: a plurality of hoses is laid from a first clean room of a first, higher clean room class to a second clean room of a second, lower clean room class, a sterile filter set is provided in the first clean room, a fluid container, a discharge container and a filter test device are provided in the second clean room, a first hose is connected to the filter set and the fluid container, a second hose is connected to the filter set and the discharge container, the filter set is flushed in that a flushing fluid is conducted out of the fluid container through the filter set and into the discharge container, after the filter set has been flushed, the first hose is disconnected from the fluid container and is connected to the filter test device, and a filter test is carried out using the filter test device.

### CROSS-REFERENCE TO RELATED APPLICATIONS

This application is a U.S. National Phase Application under 35 U.S.C. 371 of International Application No. PCT/EP2023/071608, filed on Aug. 3, 2023, which claims the benefit of German Patent Application No. 10 2022 119 936.3, filed on Aug. 8, 2022. The entire disclosures of the above patent applications are incorporated herein by reference.

### FIELD

The invention relates to a method for carrying out a filter test and a sterile filter set with instructions for carrying out such a method.

### BACKGROUND

This section provides background information related to the present disclosure which is not necessarily prior art.

Annex 1 of the EU GMP Guide “Manufacture of Sterile Medicinal Products” is considered an important European regulation for the manufacture of sterile medicinal products. As part of a revision of Annex 1 of the EU GMP Guide, which is ongoing on the date determining the priority of the present property right, the requirements for methods relating to pre-use/post-sterilization integrity testing (PUPSIT) will be discussed.

Pre-use/post-sterilization integrity testing (PUPSIT) is understood to mean a method for carrying out a filter test that is performed after sterilization of the elements required for filtration and before filtration of a fluid using the elements. In particular, a filter test is used to check a filter, in particular a membrane built into the filter, to ensure the integrity and/or functionality of the filter.

Known devices for carrying out PUPSIT methods are complex and comprise a plurality of elements, in particular more than 20 elements. Furthermore, the known devices are very specifically adapted to a use and/or a space in which the device is set up. Thus, it is not possible to flexibly adapt the device to a different use and/or for placement in a different space.

Furthermore, known devices for carrying out the PUPSIT method comprise plastic elements and/or silicone tubes. The disadvantage of this is that such devices are not thermally stable and therefore cannot be steam sterilized. Furthermore, such devices can only be used in specially equipped clean rooms of clean room class A or isolators with an extended space requirement or in a clean room with a lower clean room class.

Furthermore, a flexible adaptation of the known devices to changed test conditions and/or a structural change of the known devices is only partially possible.

### SUMMARY

This section provides a general summary of the disclosure, and is not a comprehensive disclosure of its full scope or all of its features.

The invention is therefore based on the task of providing a method for carrying out a filter test and a sterile filter set with instructions for carrying out such a method, wherein the aforementioned disadvantages are at least partially eliminated and preferably avoided.

The task is solved by providing the present technical teaching, in particular the teaching of the independent claims as well as the embodiments disclosed in the dependent claims and the description.

The task is solved in particular by providing a method for carrying out a filter test, in which, in a step a), a plurality of hoses is or will be laid from a first clean room of a first, higher clean room class into a second clean room of a second, lower clean room class. Furthermore, in the first step a), a sterile filter set is provided in the first clean room. In addition, in the first step a) at least one fluid container, at least one discharge container and a filter test device are provided in the second clean room. In a step b), at least a first hose of the plurality of hoses is or will be fluidically connected to the sterile filter set with at least a first end. In a step c), the at least one first hose of the plurality of hoses is or will be fluidically connected to the at least one fluid container with at least one second end. In a step d), at least a second hose of the plurality of hoses is or will be fluidically connected to the sterile filter set with at least a first end, wherein the at least a second hose of the plurality of hoses opens into the at least a first discharge container with at least a second end. In a step e), the filter set is flushed in that a flushing fluid, in particular a predetermined amount of flushing fluid, is conducted out of the at least one fluid container through the filter set into the at least one discharge container. In a step f), after the filter set has been flushed, the second end of the at least one first hose is separated from the fluid container and fluidically connected to the filter test device. In a step g), a filter test is carried out using the filter test device.

Advantageously, the method makes it possible to carry out a filter test quickly and easily after sterilization and before use of the filter. Furthermore, advantageously, only a small number of elements are required to carry out the method. Advantageously, this also makes it possible to adapt the method flexibly to clean rooms of different sizes.

Furthermore, it is possible to carry out the method with existing elements, in particular hoses and valves, which means that, advantageously, no special elements have to be provided.

Furthermore, during the carrying out of the method, advantageously, no connections, in particular aseptic connections, in particular connections of hoses to the filter set, in particular to valves, and/or fluidically connections within the filter set, are opened in the first clean room. In particular, during the carrying out of the method, it is advantageously not necessary to open a connection, in particular an aseptic connection, in the first clean room. In particular, it is advantageously not necessary to disconnect a connection from one hose of the plurality of hoses to the filter set after this connection has been established. This advantageously prevents a fluid or gas from leaking into the first clean room.

In particular, it is possible to conduct a predetermined amount of flushing fluid through the filter set using the method. This can be used to advantageously check the flushing of the filter set, in particular to carry it out in accordance with guidelines.

A clean room is understood to be a room in which the concentration of airborne particles, in particular aerosols, is controlled and kept below predefined threshold values. In particular, a clean room is classified on the basis of the predefined threshold values, wherein a clean room can be assigned a clean room class. In particular, a higher clean room class compared to a lower clean room class means that the predefined threshold values in the higher clean room class are lower than in the lower clean room class.

In a configuration, a clean room of clean room class A is used as the first clean room, wherein the clean room class is determined in accordance with the version of Annex 1 of the EU GMP Guide valid on the date of priority of the present property right. Alternatively or additionally, a clean room of clean room class B or C will be used as the second clean room. Advantageously, this makes it possible to carry out the method in a small first clean room of the first, higher clean room class. This makes it possible to carry out the method in a cost-effective way. Furthermore, it is possible to carry out the method universally and to adapt it flexibly to clean rooms of different sizes.

In a configuration, at least one hose of the plurality of hoses, in particular all hoses of the plurality of hoses, is configured as a Teflon hose. Alternatively or additionally, at least one hose of the plurality of hoses, in particular all hoses of the plurality of hoses, comprises at least one Tri-Clamp connection. Advantageously, Teflon is inert and thermally stable—in particular in contrast to silicone hoses of the known devices—and can therefore be sterilized using steam. Furthermore, it is advantageously possible to sterilize a Teflon hose—in particular in contrast to silicone hoses of the known devices—in particular from the outside with H₂O₂.

In a configuration, compressed air is conducted through the filter set during the filter test. In particular, the compressed air is first conducted through an air filter and then into the filter set. In particular, a Millipore Express Opticap XL 150 air filter is used as the air filter, wherein a pressure of at most 6.9 bar can be applied to the air filter.

In a configuration, at least one hose of the plurality of hoses comprises a quick-connect coupling, in particular an MPC coupling.

In a configuration, a multi-port valve, in particular a 3-way valve, in particular an M-block or a T-block, is used as the first valve and/or the second valve.

According to a further development of the invention, it is provided that steps a) to g) are carried out aseptically—in particular in an aseptic environment and/or under aseptic conditions.

In a configuration of the method, all steps of the method are carried out aseptically—in particular in an aseptic environment and/or under aseptic conditions.

In particular, the filter set, in particular all components of the filter set, is autoclaved individually or partially assembled before step a). The filter set is then assembled and connected in the first clean room under aseptic conditions.

According to a further development of the invention, it is provided that the filter set will be subjected to compressed air and/or an inert gas, in particular nitrogen or helium, after step e) and before step f), in order to at least partially dry the filter set using the compressed air and/or the inert gas.

It is advantageous that it is possible to dry the first hose and the filter set at least partially before carrying out the filter test. This ensures that the flushing fluid is removed from the hose.

In a configuration of the method, a container, in particular a screw-top jar, is used into which the compressed air and/or the inert gas escaping from the filter set is introduced and which in particular receives the flushing fluid conveyed by the compressed air and/or inert gas from the filter set.

According to a further development of the invention, it is provided that at least one first product container will be provided in the first clean room. Furthermore, at least one second product container will be provided in the second clean room. In a step h), the filter set is or will be fluidically connected to the at least one first product container. In a step i), after the filter test, the second end of the first hose is separated fluidically from the filter test device and connected to the at least one second product container. In a step j), a product fluid is conducted from the second product container through the filter set into the first product container, wherein the product fluid is filtered in the filter set.

Using the method, it is advantageously possible to carry out a filtration of the product fluid in a simple and fast manner after sterilization and after the filter test.

In particular, the product fluid is conducted out of the filter set into the first product container via a third hose.

In particular, steps h) to j) are carried out aseptically-in particular in an aseptic environment and/or under aseptic conditions.

In addition, advantageously no, in particular aseptic, connections, in particular connections of hoses to the filter set, in particular to valves, and/or fluidically active connections within the filter set, are opened in the first clean room during carrying out of the filtration. In particular, it is advantageously not necessary to open an, in particular aseptic, connection in the first clean room during the filtration.

According to a further development of the invention, it is provided that the sterile filter set comprises at least one fluid filter, at least three hoses and at least two valves. Furthermore, in step a) a first port of the at least one fluid filter is or will be fluidically connected to a second port of a first valve of the at least two valves. Furthermore, in step a), a second port of the at least one fluid filter is or will be fluidically connected to a first port of a second valve of the at least two valves. Furthermore, in step b), the first end of the first hose is or will be fluidically connected to a first port of the first valve. Furthermore, in step d), the first end of the second hose is or will be fluidically connected to a second port of the second valve. In addition, in step e), in a first single filter operating state of the filter set, the first valve and the second valve are adjusted in such a way that the at least one fluid filter is flushed with the flushing fluid from the fluid container, wherein the flushing fluid enters the filter set via the first port of the first valve and exits the filter set via the second port of the second valve, and wherein the flushing fluid is conducted via the second hose into the at least one discharge container. Furthermore, in step g), the first single filter operating state is set in order to carry out the filter test.

In particular, the flushing fluid or the particularly sterile compressed air enters the filter set via the first port of the first valve in the first single filter operating state. After that, the flushing fluid or the particularly sterile compressed air is conducted via the second port of the first valve and the first port of the fluid filter into the at least one fluid filter. The flushing fluid or the particularly sterile compressed air then enters the second valve via the second port of the fluid filter and the first port of the second valve and will be conducted out of the filter set via the second port of the second valve. In particular, in the first single filter operating state, all further ports of the filter set that are not explicitly mentioned are additionally blocked, so that the flushing fluid or the particularly sterile compressed air can only be conducted through the explicitly mentioned ports in the first single filter operating state.

In a configuration, a multi-port valve, in particular a 3-way valve, in particular an M-block, is used as at least one of the at least two valves, in particular as the at least two valves. Alternatively, a T-block is used as at least one of the at least two valves, in particular as the at least two valves.

According to a further development of the invention, it is provided that after step e) and before step f), in a second single filter operating state of the filter set, the first valve is set in such a way that compressed air and/or an inert gas enters the filter set via the first port of the first valve and exits the filter set via a third port of the first valve.

In particular, the compressed air and/or the inert gas is only conducted through the first valve in order to advantageously at least partially dry the first hose and/or the first valve. Preferably, the compressed air and/or the inert gas is conducted through the first valve from the fluid container that has been emptied during the flushing.

In particular, in the second single filter operating state, the compressed air and/or the inert gas enters the filter set via the first port of the first valve. After that, the compressed air and/or the inert gas is conducted out of the filter set via the third port of the first valve. In particular, in the second single filter operating state, the second port of the first valve is additionally blocked so that the compressed air and/or the inert gas cannot be conducted into the at least one fluid filter. Advantageously, the at least one fluid filter remains wetted for the subsequent filter test.

In an embodiment, after step e) and before step f), in the first single filter operating state of the filter set, the first valve and the second valve are set in such a way that compressed air and/or an inert gas enters the filter set via the first port of the first valve and exits the filter set via the second port of the second valve. In particular, the compressed air and/or the inert gas is conducted via the second port of the first valve and the first port of the fluid filter into the at least one fluid filter and via the second port of the fluid filter and the first port of the second valve into the second valve. Preferably, the compressed air and/or the inert gas, in particular at a pressure of at most 2.0 bar, is conducted from the fluid container that has been emptied during the flushing through the filter set. Advantageously, it is thus possible to at least partially dry the at least one fluid filter.

According to a further development of the invention, it is provided that in step a), the third port of the second valve is or will be fluidically connected to a first port of the first product container. Alternatively, in step h), the third port of the second valve is or will be fluidically connected to a first port of the first product container. Furthermore, in step j), in a third single filter operating state of the filter set, the first valve and the second valve are set in such a way that the product fluid from the second product container is filtered using the at least one fluid filter wherein the product fluid enters the filter set via the first port of the first valve and exits the filter set via the third port of the second valve and is conducted into the first product container.

In particular, in the third single filter operating state, the product fluid enters the filter set via the first port of the first valve. After that, the product fluid is conducted through the second port of the first valve and the first port of the fluid filter into the at least one fluid filter. The product fluid then enters the second valve through the second port of the fluid filter and the first port of the second valve and is conducted out of the filter set into the first product container through the third port of the second valve. In particular, in the third single filter operating state, the third port of the first valve and the second port of the second valve are blocked, so that the product fluid can be conducted in the third single filter operating state exclusively into the first product container after passing through the filter set.

According to a further development of the invention, it is provided that before step j), the second hose will be separated fluidically from the filter set.

In a configuration, before step j), the second hose is separated fluidically from the filter set and brought from the first clean room into the second clean room. In particular, the second hose is brought from the first clean room into the second clean room via at least one duct opening.

According to a further development of the invention, it is provided that after step j) the second hose is separated fluidically from the filter set.

In a configuration, after step j) the second hose is separated fluidically from the filter set and brought out of the first clean room into the second clean room. In particular, the second hose is brought out of the first clean room into the second clean room via at least one duct opening.

According to a further development of the invention, it is provided that the first clean room is configured as a glove box. This advantageously makes it possible to keep the first clean room small and thus also to operate it cost-effectively.

In particular, the hoses are connected and/or disconnected fluidically from the ports via the gloves of the glove box.

According to a further development of the invention, it is provided that the at least one filter set comprises a first fluid filter, a second fluid filter, the first valve, the second valve, a third valve, a fourth valve, the first hose, a first second hose, a second second hose and the third hose. Furthermore, in step a) a first port of the first fluid filter is or will be fluidically connected to the second port of the first valve. Furthermore, in step a) a second port of the first fluid filter is or will be fluidically connected to a first port of the third valve. Furthermore, in step a) a second port of the third valve is or will be fluidically connected to a first port of the fourth valve. Furthermore, in step a), a first port of the second fluid filter is or will be fluidically connected to a second port of the fourth valve. Furthermore, in step a), a second port of the second fluid filter is or will be fluidically connected to the first port of the second valve. Furthermore, in step b), the first end of the first hose is or will be fluidically connected to the first port of the first valve. Furthermore, in step d), a first end of the first second hose is or will be fluidically connected to a third port of the fourth valve. Furthermore, in step d), a first end of the second second hose is or will be fluidically connected to the second port of the second valve. In addition, in step e), in a first first double filter operating state of the filter set, the first valve, the second valve, the third valve and the fourth valve are set in such a way that the first fluid filter and the second fluid filter are flushed with the flushing fluid from the fluid container wherein the flushing fluid enters the filter set via the first port of the first valve and exits the filter set via the second port of the second valve, wherein the flushing fluid is conducted via the second second hose into the at least one discharge container. Alternatively or additionally, in step e), in a second first double filter operating state of the filter set, the first valve, the second valve, the third valve and the fourth valve are set in such a way that the first fluid filter is flushed with the flushing fluid from the fluid container, wherein the flushing fluid enters the filter set via the first port of the first valve and exits the filter set via the third port of the fourth valve, wherein the flushing fluid is conducted via the first second hose into the at least one discharge container. Furthermore, in a first sub-step g1), a first end of the third hose is or will be fluidically connected to a third port of the third valve. In addition, in a second sub-step g2), in a second double filter operating state of the filter set, the first valve, the third valve and the fourth valve are set in such a way that the first fluid filter can be tested, wherein in particular sterile compressed air enters the filter set via the first port of the first valve and exits the filter set via the third port of the fourth valve, wherein the second fluid filter being separated fluidically from the filter test device. In addition, in a third sub-step g3), in a third double filter operating state of the filter set, a second end of the third hose is fluidically connected to the filter test device and the second valve, the third valve and the fourth valve are adjusted in such a way that the second fluid filter can be tested, wherein in particular sterile compressed air enters the filter set via the third port of the third valve and exits the filter set via the second port of the second valve, wherein the first fluid filter is fluidically separated from the filter test device.

In particular, in the first first double filter operating state, the flushing fluid enters the filter set via the first port of the first valve. Thereafter, the flushing fluid is conducted via the second port of the first valve and the first port of the first fluid filter into the first fluid filter. Subsequently, the flushing fluid enters the third valve via the second port of the first fluid filter and the first port of the third valve. After that, the flushing fluid is conducted via the second port of the third valve and the first port of the fourth valve into the fourth valve. After that, the flushing fluid is conducted via the second port of the fourth valve and the first port of the second fluid filter into the second fluid filter. The flushing fluid then enters the second valve via the second port of the second fluid filter and the first port of the second valve and is conducted out of the filter set via the second port of the second valve. In particular, in the first first double filter operating state, all further ports of the filter set not explicitly mentioned are additionally blocked, so that the flushing fluid can only be conducted through the explicitly mentioned ports in the first first double filter operating state.

In particular, in the second first double filter operating state, the flushing fluid enters the filter set via the first port of the first valve. After that, the flushing fluid is conducted into the first fluid filter via the second port of the first valve and the first port of the first fluid filter. The flushing fluid then enters the third valve via the second port of the first fluid filter and the first port of the third valve. After that, the flushing fluid is conducted into the fourth valve via the second port of the third valve and the first port of the fourth valve. After that, the flushing fluid is conducted out of the filter set via the third port of the fourth valve. In particular, in the second first double filter operating state, all further ports of the filter set that are not explicitly mentioned are blocked, so that the flushing fluid can only be conducted through the explicitly mentioned ports in the second first double filter operating state.

In particular, the particularly sterile compressed air enters the filter set via the first port of the first valve in the second double filter operating state. After that, the particularly sterile compressed air is conducted via the second port of the first valve and the first port of the first fluid filter into the first fluid filter. Subsequently, the particularly sterile compressed air enters the third valve via the second port of the first fluid filter and the first port of the third valve. After that, the particularly sterile compressed air is conducted into the fourth valve via the second port of the third valve and the first port of the fourth valve. Subsequently, the particularly sterile compressed air is conducted out of the filter set via the third port of the fourth valve. In particular, in the second double filter operating state, the third port of the first valve, the third port of the third valve and the second port of the fourth valve are blocked, so that the particularly sterile compressed air can only be conducted through the first fluid filter in the second double filter operating state and that the second fluid filter is separated fluidically from the first fluid filter.

In particular, in the third double filter operating state, the particularly sterile compressed air enters the filter set via the third port of the third valve. After that, the particularly sterile compressed air is conducted via the second port of the third valve and the first port of the fourth valve into the fourth valve. Subsequently, the particularly sterile compressed air is conducted via the second port of the fourth valve and the first port of the second fluid filter into the second fluid filter. The particularly sterile compressed air then enters the second valve via the second port of the second fluid filter and the first port of the second valve. The particularly sterile compressed air is then conducted out of the filter set via the second port of the second valve. In particular, in the third double filter operating state, the first port of the third valve and the third port of the fourth valve are blocked, so that the particularly sterile compressed air can be conducted in the third double filter operating state only through the second fluid filter and that the first fluid filter is separated fluidically from the second fluid filter.

In an embodiment, after step e) and before step f), in a fourth double filter operating state, the first valve is set in such a way that compressed air and/or an inert gas enters the filter set via the first port of the first valve and exits the filter set via a third port of the first valve.

In a further embodiment, after step e) and before step f), in the first first double filter operating state of the filter set, the first valve, the second valve, the third valve and the fourth valve are set in such a way that compressed air and/or an inert gas enters the filter set via the first port of the first valve and exits the filter set via a second port of the second valve. Preferably, the compressed air and/or the inert gas is conducted from the fluid container that has been emptied during the flushing process through the filter set, in particular through the first fluid filter and the second fluid filter. This advantageously makes it possible to at least partially dry the two fluid filters.

In a further embodiment, after step e) and before step f) in the second first double filter operating state of the filter set, the first valve, the second valve, the third valve and the fourth valve are set in such a way that compressed air and/or an inert gas enters the filter set via the first port of the first valve and exits the filter set via the third port of the fourth valve. Preferably, the compressed air and/or the inert gas is conducted from the fluid container that has been emptied during the flushing process through the filter set, in particular through the first fluid filter. This advantageously makes it possible to dry the first fluid filter at least partially.

In a configuration, the second port of the third valve is or will be fluidically connected to the first port of the fourth valve using a fourth hose. In particular, a Teflon hose with, in particular, two tri-clamp connections and/or with at least one 90° bend, in particular at least two 90° bends, is used as the fourth hose.

In a configuration, a multi-way valve, in particular a 3-way valve, in particular an M-block or a T-block, is used as at least one valve selected from a group consisting of the first valve, the second valve and the fourth valve. In particular, a multi-way valve, in particular a 3-way valve, in particular an M-block or a T-block, will be used as the first valve, as the second valve and as the fourth valve.

In a configuration, a 3-way stopcock will be used as the third valve. Alternatively, an M-block will be used as the third valve.

In particular, it is easily possible to expand the filter set by a further fluid filter, in particular a third fluid filter. To do this, the further fluid filter and two further valves are arranged fluidically between the second fluid filter and the second valve, in a manner analogous to the expansion by the second fluid filter.

According to a further development of the invention, it is provided that in step e), after flushing the filter set in the first first double filter operating state and/or the second first double filter operating state, the second end of the third hose will be fluidically connected to the fluid container. After that, in a third first double filter operating state of the filter set, the first valve, the second valve, the third valve and the fourth valve are set in such a way that the second fluid filter is flushed with the flushing fluid from the fluid container. In this process, the flushing fluid enters the filter set via the third port of the third valve and exits the filter set via the second port of the second valve, wherein the flushing fluid is conducted into the at least one discharge container via the second second hose.

In particular, in the third first double filter operating state, the flushing fluid enters the filter set via the third port of the third valve. Thereafter, the flushing fluid is conducted into the fourth valve via the second port of the third valve and the first port of the fourth valve. Thereafter, the flushing fluid is conducted into the second fluid filter via the second port of the fourth valve and the first port of the second fluid filter. The flushing fluid then enters the second valve via the second port of the second fluid filter and the first port of the second valve and is conducted out of the filter set via the second port of the second valve. In particular, in the third first double filter operating state, all further ports of the filter set that are not explicitly mentioned are additionally blocked, so that the flushing fluid can only be conducted through the explicitly mentioned ports in the third first double filter operating state.

In an embodiment, after step e) and before step f) in the third first double filter operating state of the filter set, the first valve, the second valve, the third valve and the fourth valve are set in such a way that compressed air and/or an inert gas enters the filter set via the third port of the third valve and exits the filter set via the second port of the second valve. Preferably, the compressed air and/or the inert gas, in particular at a pressure of at most 2.0 bar, is conducted from the fluid container that has been emptied during the flushing, through the filter set, in particular through the second fluid filter. Advantageously, it is thus possible to dry the second fluid filter at least partially.

According to a further development of the invention, it is provided that after step e) and before the first sub-step g1), the filter set is set in a fourth double filter operating state. In this case, the filter set is dried with an inert gas, in particular with nitrogen.

Alternatively or in addition, after the third sub-step g3), the filter set is set in the fourth double filter operating state. In this process, the filter set is dried using an inert gas, in particular using nitrogen.

In the fourth double filter operating state of the filter set, the first valve, the second valve, the third valve and the fourth valve are set in such a way that the third valve and the fourth valve are supplied with the inert gas wherein the inert gas enters the filter set via the third port of the third valve and exits the filter set via the third port of the fourth valve, wherein the inert gas is conducted into the at least one discharge container via the first second hoses. In particular, the inert gas is conducted into the fourth valve via the second port of the third valve and the first port of the fourth valve. In particular, in the fourth double filter operating state, all further ports of the filter set not explicitly mentioned are additionally blocked, so that the inert gas can only be conducted through the explicitly mentioned ports in the fourth double filter operating state.

In a configuration, the inert gas, in particular nitrogen, enters the filter set via the third port of the third valve and exits the filter set via the third port of the fourth valve, wherein the first fluid filter is fluidically separated from the second fluid filter.

In particular, the inert gas, in particular the nitrogen, is conducted into the filter set at a pressure of at most 2.0 bar.

According to a further development of the invention, it is provided that in step a), the third port of the second valve is or will be fluidically connected to the first port of the first product container. In addition, in step j), in a fourth double filter operating state of the filter set, the first valve, the second valve, the third valve and the fourth valve are set in such a way that the product fluid from the second product container is filtered using the first fluid filter and the second fluid filter, wherein the product fluid enters the filter set via the first port of the first valve and exits the filter set via the third port of the second valve and is conducted into the first product container.

In particular, in the fourth double filter operating state, the product fluid enters the filter set via the first port of the first valve. The product fluid is then conducted into the first fluid filter via the second port of the first valve and the first port of the first fluid filter. The product fluid then enters the third valve via the second port of the first fluid filter and the first port of the third valve. After that, the product fluid is conducted through the second port of the third valve and the first port of the fourth valve into the fourth valve. After that, the product fluid is conducted via the second port of the fourth valve and the first port of the second fluid filter into the second fluid filter. The product fluid then enters the second valve via the second port of the second fluid filter and the first port of the second valve and is then conducted out of the filter set via the third port of the second valve. In particular, in the fourth double filter operating state, all other ports of the filter set not explicitly mentioned are also blocked, so that the product fluid can only be conducted through the explicitly mentioned ports in the fourth double filter operating state. In particular, in the fourth double filter operating state, the third port of the first valve, the second port of the second valve, the third port of the third valve and the third port of the fourth valve are blocked, so that the product fluid in the fourth double filter operating state can be conducted exclusively into the first product container after passing through the filter set.

According to a further development of the invention, it is provided that in step h) the third port of the second valve is or will be fluidically connected to a first port of the first product container. In addition, in step j), in the fourth double filter operating state of the filter set, the first valve, the second valve, the third valve and the fourth valve are set in such a way that the product fluid from the second product container is filtered using the first fluid filter and the second fluid filter, wherein the product fluid enters the filter set via the first port of the first valve and exits the filter set via the third port of the second valve and is conducted into the first product container.

The task is also solved in that a sterile filter set is provided with at least one fluid filter, at least three hoses, at least two valves and instructions for use. The instructions include information for carrying out a method according to the invention or a method according to one or more of the previously explained embodiments. In connection with the sterile filter set, there are in particular the advantages that have already been explained in connection with the method.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is explained in more detail in the following drawing. The following show:

FIG. 1 shows a first embodiment of a sterile filter set,

FIG. 2 shows a flow diagram of an embodiment of the method for carrying out a filter test,

FIG. 3 shows a schematic representation of the first embodiment of the sterile filter set with a fluid filter in a first procedural step,

FIG. 4 shows a schematic representation of the first embodiment of the sterile filter set with the fluid filter in a second procedural step,

FIG. 5 shows a schematic representation of the first embodiment of the sterile filter set with the fluid filter in a third procedural step,

FIG. 6 shows a schematic representation of a second embodiment of the sterile filter set with two fluid filters in a first procedural step,

FIG. 7 shows a schematic representation of the second embodiment of the sterile filter set with two fluid filters in a second procedural step,

FIG. 8 shows a schematic representation of the second embodiment of the sterile filter set with two fluid filters in a third procedural step,

FIG. 9 shows a schematic representation of the second embodiment of the sterile filter set with two fluid filters in a fourth procedural step, and

FIG. 10 shows a schematic representation of the second embodiment of the sterile filter set with two fluid filters in a fifth procedural step.

### DETAILED DESCRIPTION

Example embodiments will now be described more fully with reference to the accompanying drawings.

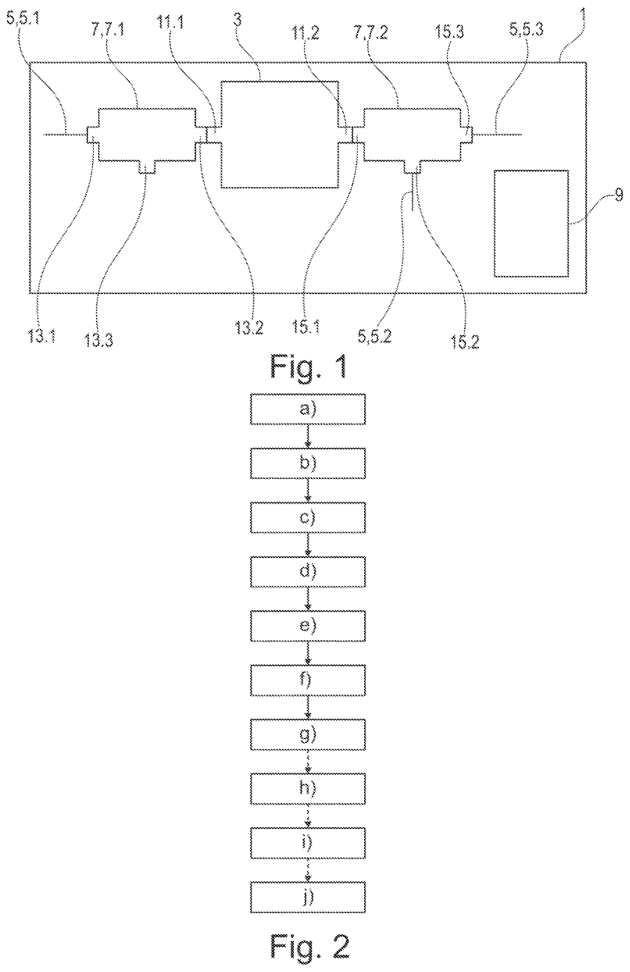

FIG. 1 shows a first embodiment of a sterile filter set 1. The sterile filter set 1 comprises at least one fluid filter 3, at least two hoses 5, preferably at least three hoses 5, at least two valves 7, in particular a first valve 7.1 and a second valve 7.2, and instructions for use 9. The instructions for use 9 include instructions for carrying out a filter test.

Optionally, the instructions for use 9 include, in particular, instructions for carrying out a filtration using the sterile filter set 1.

In particular, a first port 11.1 of the at least one fluid filter 3 is fluidically connected or connectable to a second port 13.2 of the first valve 7.1. Furthermore, a second port 11.2 of the at least one fluid filter 3 is fluidically connected or connectable to a first port 15.1 of the second valve 7.2. Furthermore, a first end of a first hose 5.1 is fluidically connected or connectable to a first port 13.1 of the first valve 7.1. Furthermore, a first end of a second hose 5.2 is fluidically connected or connectable to a second port 15.2 of the second valve 7.2. In addition, preferably a first end of a third hose 5.3 is fluidically connected or connectable to a third port 15.3 of the second valve 7.2.

The method for carrying out a filter test is described in more detail using the following figures.

FIG. 2 shows a flow diagram of an embodiment of the method for carrying out a filter test.

In a first step a), the sterile filter set 1 is provided in a first clean room 17.1 of a first, higher clean room class. Furthermore, at least one fluid container 19, at least one discharge container 21 and a filter test device 23 are provided in a second clean room 17.2 of a second, lower clean room class. In addition, a plurality of hoses 5 will be laid from the first clean room 17.1 to the second clean room 17.2. Alternatively, the plurality of hoses 5 is laid from the first clean room 17.1 to the second clean room 17.2.

In a second step b), the first end of the first hose 5.1 will be fluidically connected to the sterile filter set 1. Alternatively, the first end of the first hose 5.1 is fluidically connected to the sterile filter set 1.

In a third step c), at least one second end of the at least one first hose 5.1 will be fluidically connected to the at least one fluid container 19. Alternatively, the at least one second end of the at least one first hose 5.1 is fluidically connected to the at least one fluid container 19.

In a fourth step d), at least one first end of at least one second hose 5.2 of the plurality of hoses 5 will be fluidically connected to the sterile filter set 1. Alternatively, the at least one first end of the at least one second hose 5.2 is fluidically connected to the sterile filter set 1. Furthermore, the at least one second hose 5.2 opens with at least one second end into the at least one discharge container 21.

In a fifth step e), the filter set 1 is flushed in that a flushing fluid is conducted from the at least one fluid container 19 through the filter set 1 into the at least one discharge container 21.

In a sixth step f), after flushing the filter set 1, the second end of the at least one first hose 5.1 is separated from the fluid container 19 and fluidically connected to the filter test device 23.

In a seventh step g), a filter test is carried out using the filter test device 23.

Preferably, compressed air and/or an inert gas is applied to filter set 1 after the fifth step e) and before the sixth step f) in order to at least partially dry filter set 1, in particular the first hose 5.1 and the first valve 7.1, using the compressed air and/or the inert gas.

Preferably, at least one first product container 25.1 is provided in the first clean room 17.1. Alternatively or additionally, at least one second product container 25.2 is preferably provided in the second clean room 17.2.

In an optional eighth step h), the filter set 1 will be fluidically connected to the at least one first product container 25.1. Alternatively, the filter set 1 is fluidically connected to the at least one first product container 25.1.

In an optional ninth step i), after the filter test, the second end of the first hose 5.1 is separated fluidically from the filter test device 23 and connected to the at least one second product container 25.2.

In an optional tenth step j), a product fluid is conducted from the second product container 25.2 through the filter set 1 into the first product container 25.1, wherein the product fluid is filtered in the filter set 1.

In particular, steps h) to j) describe an optional filtration of a product fluid after a filter test has been carried out using steps a) to g).

Preferably, steps a) to g), in particular steps a) to j), are carried out aseptically.

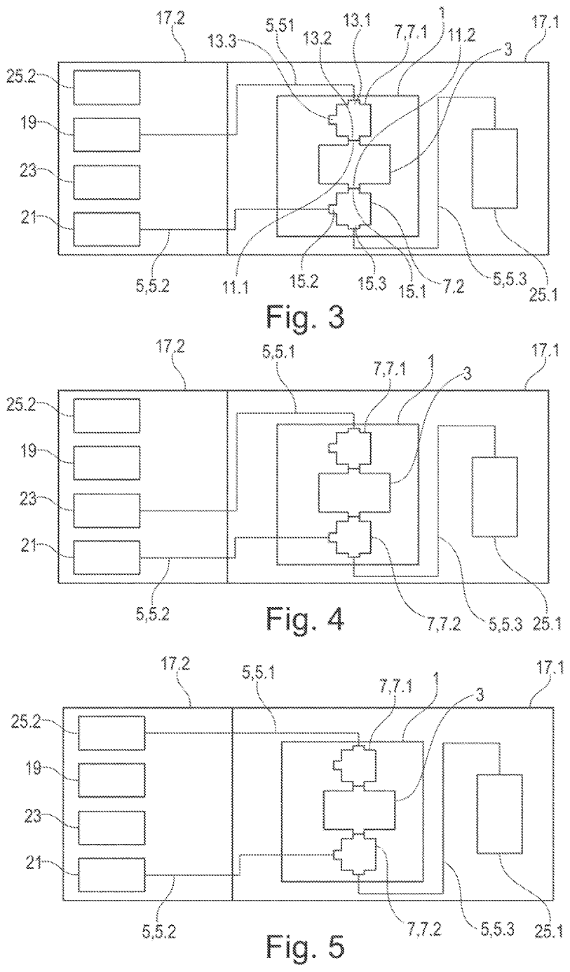

FIGS. 3 to 5 show a schematic representation of the first embodiment of the sterile filter set 1 with a fluid filter 3 in three different procedural steps.

Identical elements with identical functions are provided with the same reference signs in all figures, so that reference is made to the previous description in this respect.

For a clearer presentation, the reference signs for the ports will be shown only in FIG. 3. The ports in FIGS. 4 and 5 are identical to the ports in FIG. 3.

In FIGS. 3 to 5, the second hose 5.2 fluidically connects the second port 15.2 of the second valve 7.2 and the discharge container 21 to one another. In addition, in particular the third hose 5.3 fluidically connects the third port 15.3 of the second valve 7.2 and the first product container 25 to one another.

FIG. 3 shows the fifth step e) of the method for carrying out a filter test, in particular flushing the filter set 1. The first hose 5.1 connects the first port 13.1 of the first valve 7.1 and the fluid container 19 fluidically to one another.

In a first single filter operating state of the filter set 1 in FIG. 3, the first valve 7.1 and the second valve 7.2 are set in such a way that the fluid filter 3 is flushed with the flushing fluid from the fluid container 19. In particular, the flushing fluid enters the filter set 1 via the first port 13.1 of the first valve 7.1. After that, the flushing fluid is conducted via the second port 13.2 of the first valve 7.1 and the first port 11.1 of the fluid filter 3 into the fluid filter 3. The flushing fluid then enters the second valve 7.2 via the second port 11.2 of the fluid filter 3 and the first port 15.1 of the second valve 7.2 and is conducted out of the filter set 1 via the second port 15.2 of the second valve 7.2. After that, the flushing fluid will be conducted through the second hose 5.2 into the discharge container 21. In particular, in the first single filter operating state, a third port 13.3 of the first valve 7.1 and the third port 15.3 of the second valve 7.2 are blocked, so that the flushing fluid in the first single filter operating state can only be conducted through the fluid filter 3 and into the discharge container 21.

In particular, after step e) and before step f) in the first single filter operating state of filter set 1, the first valve 7.1 and the second valve 7.2 are set in such a way that the fluid filter 3 is at least partially dried with compressed air and/or an inert gas, in particular from the fluid container 19 that has been emptied during flushing. In this process, the compressed air and/or the inert gas enters the filter set 1 via the first port 13.1 of the first valve 7.1. The compressed air and/or inert gas is conducted via the second port 13.2 of the first valve 7.1 and the first port 11.1 of the fluid filter 3 into the fluid filter 3 and via the second port 11.2 of the fluid filter 3 and the first port 15.1 of the second valve 7.2 into the second valve 7.2. The compressed air and/or inert gas is then conducted out of filter set 1 via the second port 15.2 of the second valve 7.2. The compressed air and/or inert gas is then conducted into the discharge container 21 via the second hose 5.2. In particular, in the first single filter operating state, the third port 13.3 of the first valve 7.1 and the third port 15.3 of the second valve 7.2 are blocked, so that the compressed air and/or the inert gas can only be conducted through the fluid filter 3 and into the discharge container 21 in the first single filter operating state.

Alternatively or additionally, in particular after step e) and before step f), in a second single filter operating state of the filter set 1, the first valve 7.1 is set in such a way that compressed air and/or an inert gas enters the filter set 1 via the first port 13.1 of the first valve 7.1 and exits the filter set 1 via the third port 13.3 of the first valve 7.1. In particular, in the second single filter operating state, the second port 13.2 of the first valve 7.1 is additionally blocked so that the compressed air and/or the inert gas cannot be conducted into the fluid filter 3.

The seventh step g) of the method for carrying out a filter test, in particular a filter test of the filter set 1, is shown in FIG. 4. The first hose 5.1 connects the first port 13.1 of the first valve 7.1 and the filter test device 23 fluidically to one another.

In the first single filter operating state of filter set 1 in FIG. 4, the first valve 7.1 and the second valve 7.2 are set in such a way that the fluid filter 3 is supplied with the particularly sterile compressed air from the filter test device 23. In this case, the particularly sterile compressed air enters the filter set 1 via the first port 13.1 of the first valve 7.1. After that, the particularly sterile compressed air is conducted via the second port 13.2 of the first valve 7.1 and the first port 11.1 of the fluid filter 3 into the fluid filter 3. Subsequently, the particularly sterile compressed air, in particular together with flushing fluid flushed out of the fluid filter 3 using the sterile compressed air, enters the second valve 7.2 via the second port 11.2 of the fluid filter 3 and the first port 15.1 of the second valve 7.2 and is conducted out of the filter set 1 via the second port 15.2 of the second valve 7.2. After that, the particularly compressed air is conducted via the second hose 5.2 into the discharge container 21. In particular, in the first single filter operating state, the third port 13.3 of the first valve 7.1 and the third port 15.3 of the second valve 7.2 are blocked, so that the particularly sterile compressed air in the first single filter operating state can only be conducted through the fluid filter 3 and into the discharge container 21.

The tenth step j) of the method, in particular a filtration of the product fluid in the filter set 1, is shown in FIG. 5. The first hose 5.1 fluidically connects the first port 13.1 of the first valve 7.1 and the second product container 25.2.

In a third single filter operating state of filter set 1 in FIG. 5, the first valve 7.1 and the second valve 7.2 are set in such a way that the product fluid from the second product container 25.2 is filtered using the fluid filter 3. In this case, the product fluid enters the filter set 1 via the first port 13.1 of the first valve 7.1. The product fluid is then conducted via the second port 13.2 of the first valve 7.1 and the first port 11.1 of the fluid filter 3 into the fluid filter 3. The product fluid then enters the second valve 7.2 via the second port 11.2 of the fluid filter 3 and the first port 15.1 of the second valve 7.2 and is conducted out of the filter set 1 via the third port 15.3 of the second valve 7.2. After that, the product fluid will be conducted through the third hose 5.3 into the first product container 25.1. In particular, in the third single filter operating state, the third port 13.3 of the first valve 7.1 and the second port 15.2 of the second valve 7.2 are blocked, so that the product fluid in the third single filter operating state can be conducted exclusively into the first product container 25.1 after passing through the filter set 3.

In addition, it is possible, in particular, for the second hose 5.2 to be separated from the second port 15.2 of the second valve 7.2 before the product fluid is filtered. In particular, the second hose 5.2 is then brought from the first clean room 17.1 into the second clean room 17.2, in particular via at least one duct opening.

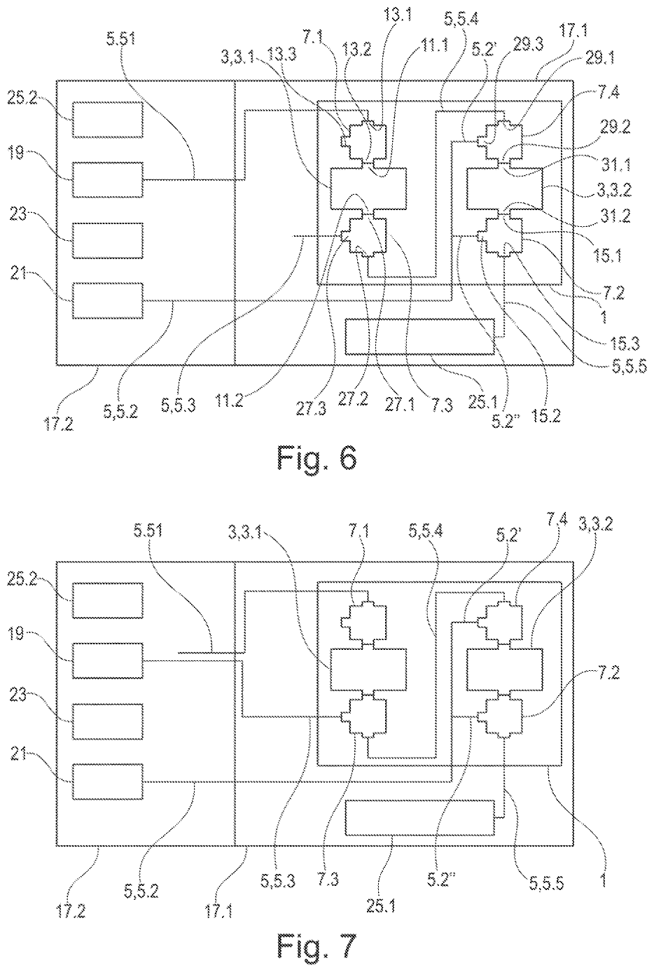

FIGS. 6 to 10 show a schematic representation of a second embodiment of the sterile filter set 1 with a first fluid filter 3.1 and a second fluid filter 3.2 in five different procedural steps.

In particular, the first port 11.1 of the first fluid filter 3.1 is fluidically connected to a second port 13.2 of the first valve 7.1. Furthermore, a second port 11.2 of the first fluid filter 3.1 is fluidically connected to a first port 27.1 of a third valve 7.3. Furthermore, a second port 27.2 of the third valve 7.3 is fluidically connected to a first port 29.1 of a fourth valve 7.4. In particular, the second port 27.2 of the third valve 7.3 is fluidically connected to the first port 29.1 of the fourth valve 7.4 using a fourth hose 5.4. Furthermore, a first port 31.1 of the second fluid filter 3.2 is fluidically connected to a second port 29.2 of the fourth valve 7.4. Furthermore, a second port 31.2 of the second fluid filter 3.2 is fluidically connected to the first port 15.1 of the second valve 7.2. Furthermore, a first end of the first hose 5.1 is fluidically connected to the first port 13.1 of the first valve 7.1. In addition, in particular a fifth hose 5.5 fluidically connects the third port 15.3 of the second valve 7.2 and the first product container 25.1 to one another.

In particular, a first end of a first second hose 5.2′ is fluidically connected to a third port 29.3 of the fourth valve 7.4, as shown in FIGS. 6 to 9. In addition, a first end of a second second hose 5.2″ is fluidically connected to the second port 15.2 of the second valve 7.2, as shown in FIGS. 6 to 9. In addition, in particular in FIGS. 6 to 9, a first end of the third hose 5.3 is fluidically connected to a third port 27.3 of the third valve 7.3. Furthermore, in FIGS. 6 to 9, the first second hose 5.2′ and the second second hose 5.2″ fluidically connect the filter set 1 and the discharge container 21 to one another. Alternatively, the first second hose 5.2′ and the second second hose 5.2″ are fluidically coupled to the second hose 5.2, wherein the second hose 5.2 opens into the discharge container 21.

For a clearer presentation, the reference signs for the ports will be shown only in FIG. 6. The ports in FIGS. 7 to 9 are identical to the ports in FIG. 6.

FIG. 6 shows the fifth step e) of the method for carrying out a filter test, in particular flushing the filter set 1. The first hose 5.1 connects the first port 13.1 of the first valve 7.1 and the fluid container 19 fluidically to one another.

In a first first double filter operating state of the filter set 1 in FIG. 6, the first valve 7.1, the second valve 7.2, the third valve 7.3 and the fourth valve 7.4 are set in such a way that the first fluid filter 3.1 and the second fluid filter 3.2 are flushed with the flushing fluid from the fluid container 19. In particular, the flushing fluid enters the filter set 1 via the first port 13.1 of the first valve 7.1. After that, the flushing fluid is conducted via the second port 13.2 of the first valve 7.1 and the first port 11.1 of the first fluid filter 3.1 into the first fluid filter 3.1. The flushing fluid then enters the third valve 7.3 via the second port 11.2 of the first fluid filter 3.1 and the first port 27.1 of the third valve 7.3 and is conducted into the fourth valve 7.4 via the second port 27.2 of the third valve 7.3 and the first port 29.1 of the fourth valve 7.4. After that, the flushing fluid is conducted via the second port 29.2 of the fourth valve 7.4 and the first port 31.1 of the second fluid filter 3.2 into the second fluid filter 3.2. The flushing fluid then enters the second valve 7.2 via the second port 31.2 of the second fluid filter 3.2 and the first port 15.1 of the second valve 7.2 and is conducted out of the filter set 1 via the second port 15.2 of the second valve 7.2. After that, the flushing fluid is conducted through the second second hose 5.2″ and in particular the second hose 5.2 into the discharge container 21. In particular, in the first first double filter operating state, the third port 13.3 of the first valve 7.1, the third port 15.3 of the second valve 7.2, the third port 27.3 of the third valve 7.3 and the third port 29.3 of the fourth valve 7.4 is blocked, so that the flushing fluid can be conducted in the first first double filter operating state exclusively through the first fluid filter 3.1, through the second fluid filter 3.2 and into the discharge container 21.

Alternatively or additionally, in a second first double filter operating state of filter set 1 in FIG. 6, the first valve 7.1, the second valve 7.2, the third valve 7.3 and the fourth valve 7.4 are set in step e) in such a way that the first fluid filter 3.1 is flushed with the flushing fluid from the fluid container 19. In particular, the flushing fluid enters the filter set 1 via the first port 13.1 of the first valve 7.1. After that, the flushing fluid is conducted via the second port 13.2 of the first valve 7.1 and the first port 11.1 of the first fluid filter 3.1 into the first fluid filter 3.1. The flushing fluid then enters the third valve 7.3 via the second port 11.2 of the first fluid filter 3.1 and the first port 27.1 of the third valve 7.3 and is conducted into the fourth valve 7.4 via the second port 27.2 of the third valve 7.3 and the first port 29.1 of the fourth valve 7.4. After that, the flushing fluid is conducted out of the filter set 1 via the third port 29.3 of the fourth valve 7.4. After that, the flushing fluid is conducted into the discharge container 21 via the first second hose 5.2′ and in particular the second hose 5.2″. In particular, in the second first double filter operating state, the third port 13.3 of the first valve 7.1, the third port 27.3 of the third valve 7.3 and the second port 29.2 of the fourth valve 7.4 is blocked, so that the flushing fluid can be conducted exclusively through the first fluid filter 3.1 and into the discharge container 21 in the second first double filter operating state.

In particular, after step e) and before step f), in a fourth double filter operating state of filter set 1, the first valve 7.1 is set in such a way that compressed air and/or an inert gas enters the first port 13.1 of the first valve 7.1 enters the filter set 1 and exits the filter set 1 via the third port 13.3 of the first valve 7.1. In particular, in the fourth double filter operating state, the second port 13.2 of the first valve 7.1 is additionally blocked so that the compressed air and/or the inert gas cannot be conducted into the first fluid filter 3.1 and/or the second fluid filter 3.2.

Alternatively or additionally, in particular after step e) and before step f), in the first first double filter operating state of filter set 1, the first valve 7.1, the second valve 7.2, the third valve 7.3 and the fourth valve 7.4 are set in such a way that the first fluid filter 3.1 and the second fluid filter 3.2 are at least partially dried with compressed air and/or an inert gas, in particular from the fluid container 19 that has been emptied during flushing. In this process, the compressed air and/or the inert gas enters the filter set 1 via the first port 13.1 of the first valve 7.1. The compressed air and/or the inert gas is conducted via the second port 13.2 of the first valve 7.1 and the first port 11.1 of the first fluid filter 3.1 into the first fluid filter 3.1 and conducted via the second port 11.2 of the first fluid filter 3 and the first port 27.1 of the third valve 7.3 into the third valve 7.3. The compressed air and/or the inert gas is conducted via the second port 27.2 of the third valve 7.3 and the first port 29.1 of the fourth valve 7.4 into the fourth valve 7.4. After that, the compressed air and/or the inert gas is conducted via the second port 29.2 of the fourth valve 7.4 and the first port 31.1 of the second fluid filter 3.2 into the second fluid filter 3.2. The compressed air and/or inert gas is then conducted via the second port 31.2 of the second fluid filter 3.2 and the first port 15.1 of the second valve 7.2 into the second valve 7.2. Subsequently, the compressed air and/or the inert gas will be conducted out of the filter set 1 via the second port 15.2 of the second valve 7.2. After that, the compressed air and/or the inert gas will be conducted into the discharge container 21 via the second second hose 5.2″. In particular, in the first first double filter operating state, the third port 13.3 of the first valve 7.1, the third port 15.3 of the second valve 7.2, the third port 27.3 of the third valve 7.3 and the third port 29.3 of the fourth valve 7.4 is blocked, so that the compressed air and/or the inert gas can be conducted in the first first double filter operating state exclusively through the first fluid filter 3.1 and the second fluid filter 3.2 into the discharge container 21.

Alternatively or additionally, in particular after step e) and before step f) in the second first double filter operating state of the filter set 1, the first valve 7.1, the second valve 7.2, the third valve 7.3 and the fourth valve 7.4 are set in such a way that the first fluid filter 3.1 is at least partially dried with compressed air and/or an inert gas, in particular from the fluid container 19 that has been emptied during the flushing. In this case, the compressed air and/or the inert gas enters the filter set 1 via the first port 13.1 of the first valve 7.1. The compressed air and/or the inert gas is conducted via the second port 13.2 of the first valve 7.1 and the first port 11.1 of the first fluid filter 3.1 into the first fluid filter 3.1 and via the second port 11.2 of the first fluid filter 3 and the first port 27.1 of the third valve 7.3 into the third valve 7.3. The compressed air and/or the inert gas is conducted via the second port 27.2 of the third valve 7.3 and the first port 29.1 of the fourth valve 7.4 into the fourth valve 7.4. After that, the compressed air and/or the inert gas is conducted out of the filter set 1 via the third port 29.3 of the fourth valve 7.4. After that, the compressed air and/or the inert gas will be conducted via the first second hose 5.2′ into the discharge container 21. In particular, in the second first double filter operating state, the third port 13.3 of the first valve 7.1, the third port 27.3 of the third valve 7.3 and the second port 29.2 of the fourth valve 7.4 is blocked, so that the compressed air and/or the inert gas can be conducted in the second first double filter operating state exclusively through the first fluid filter 3.1 into the discharge container 21.

An additional procedural step of the fifth step e) of the method for carrying out a filter test, in particular flushing the filter set 1, is shown in FIG. 7. The first hose 5.1 is fluidically separated, in particular from the fluid container 19. Furthermore, the third hose 5.3 connects the third port 27.3 of the third valve 7.3 and the fluid container 19 fluidically to one another.

In a third first double filter operating state of the filter set 1 in FIG. 7, the second valve 7.2, the third valve 7.3 and the fourth valve 7.4 are set in such a way that the second fluid filter 3.2 is flushed with the flushing fluid from the fluid container 19. In particular, the flushing fluid enters the filter set 1 via the third port 15.3 of the third valve 7.3. Thereafter, the flushing fluid is conducted via the second port 27.2 of the third valve 7.3 and the first port 29.1 of the fourth valve 7.4 into the fourth valve 7.4. After that, the flushing fluid is conducted via the second port 29.2 of the fourth valve 7.4 and the first port 31.1 of the second fluid filter 3.2 into the second fluid filter 3.2. The flushing fluid then enters the second valve 7.2 via the second port 31.2 of the second fluid filter 3.2 and the first port 15.1 of the second valve 7.2 and is conducted out of the filter set 1 via the second port 15.2 of the second valve 7.2. After that, the flushing fluid is conducted into the discharge container 21 via the second second hose 5.2″ and in particular the second hose 5.2. In particular, in the third first double filter operating state, the third port 15.3 of the second valve 7.2, the first port 27.1 of the third valve 7.3 and the third port 29.3 of the fourth valve 7.4 are blocked, so that the flushing fluid can be conducted exclusively through the second fluid filter 3.2 and into the discharge container 21 in the third first double filter operating state.

In particular, after step e) and before step f) in the third first double filter operating state of filter set 1, the second valve 7.2, the third valve 7.3 and the fourth valve 7.4 are set in such a way that the second fluid filter 3.2 is at least partially dried with compressed air and/or an inert gas, in particular from the fluid container 19 that has been emptied during the flushing. In this process, the compressed air and/or the inert gas enters the filter set 1 via the third port 27.3 of the third valve 7.3. The compressed air and/or the inert gas is conducted via the second port 27.2 of the third valve 7.3 and the first port 29.1 of the fourth valve 7.4 into the fourth valve 7.4. After that, the compressed air and/or the inert gas is conducted via the second port 29.2 of the fourth valve 7.4 and the first port 31.1 of the second fluid filter 3.2 into the second fluid filter 3.2. The compressed air and/or inert gas is then conducted via the second port 31.2 of the second fluid filter 3.2 and the first port 15.1 of the second valve 7.2 into the second valve 7.2. The compressed air and/or inert gas is then conducted out of the filter set 1 via the second port 15.2 of the second valve 7.2. After that, the compressed air and/or the inert gas is conducted via the second second hose 5.2″ into the discharge container 21. In particular, in the third first double filter operating state, the third port 15.3 of the second valve 7.2, the first port 27.1 of the third valve 7.3 and the third port 29.3 of the fourth valve 7.4 is blocked, so that the compressed air and/or the inert gas can be conducted in the third first double filter operating state exclusively through the second fluid filter 3.2 into the discharge container 21.

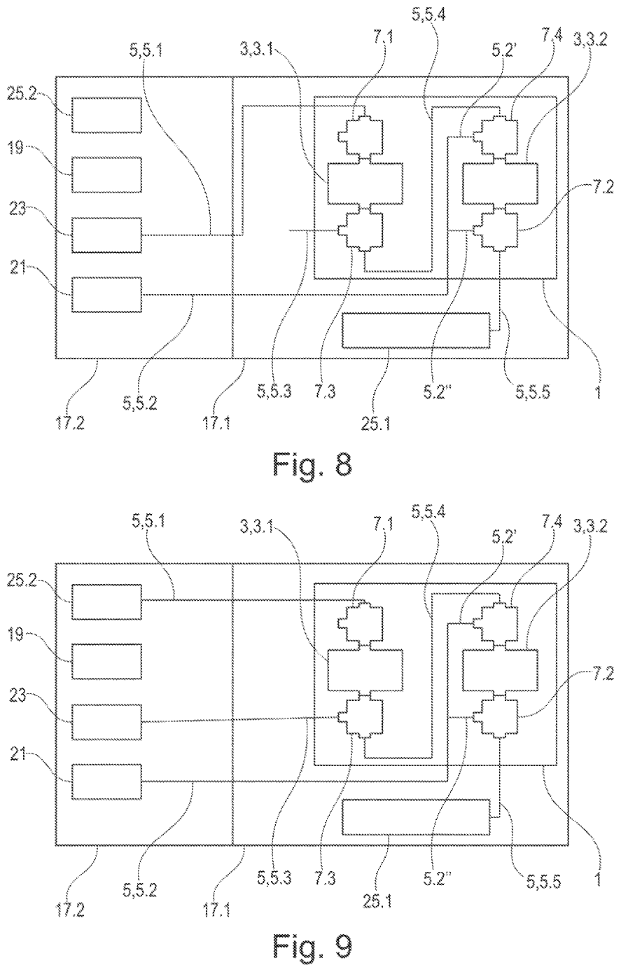

A second sub-step g2) of the seventh step g) of the method for carrying out a filter test, in particular a filter test of filter set 1, is shown in FIG. 8. The first hose 5.1 connects the first port 13.1 of the first valve 7.1 and the filter test device 23 fluidically to one another.

In a second double filter operating state of filter set 1 in FIG. 8, the first valve 7.1, the third valve 7.3 and the fourth valve 7.4 are set in such a way that the first fluid filter 3.1 is supplied with the particularly sterile compressed air from the filter test device 23, wherein the second fluid filter 3.2 is separated fluidically from the filter test device 23. In this case, the particularly sterile compressed air enters the filter set 1 via the first port 13.1 of the first valve 7.1. After that, the particularly sterile compressed air is conducted via the second port 13.2 of the first valve 7.1 and the first port 11.1 of the first fluid filter 3.1 into the first fluid filter 3.1. The particularly sterile compressed air then enters the third valve 7.3 via the second port 11.2 of the first fluid filter 3.1 and the first port 27.1 of the third valve 7.3. After that, the particularly sterile compressed air is conducted via the second port 27.2 of the third valve 7.3 and the first port 29.1 of the fourth valve 7.4 into the fourth valve 7.4. Subsequently, the particularly sterile compressed air is conducted out of the filter set 1 via the third port 29.3 of the fourth valve 7.4. After that, the sterile compressed air, in particular together with the flushing fluid flushed out of the first fluid filter 3.1 using the sterile compressed air, is conducted via the first second hose 5.2′ and the second hose 5.2 in particular into the discharge container 21. In particular, in the second double filter operating state, the third port 13.3 of the first valve 7.1, the third port 27.3 of the third valve 7.3 and the second port 29.2 of the fourth valve 7.4 are blocked, so that the particularly sterile compressed air can be conducted in the second double filter operating state exclusively through the first fluid filter 3.1 and into the discharge container 21.

A third sub-step g2) of the seventh step g) of the method for carrying out a filter test, in particular a filter test of the filter set 1, is shown in FIG. 9. The third hose 5.3 connects the third port 27.3 of the third valve 7.3 and the filter test device 23 fluidically to one another.

In a third double filter operating state of the filter set 1 in FIG. 9, the second valve 7.2, the third valve 7.3 and the fourth valve 7.4 are set in such a way that the second fluid filter 3.2 is supplied with the particularly sterile compressed air from the filter test device 23, wherein the first fluid filter 3.1 is separated fluidically from the filter test device 23. In this case, the particularly sterile compressed air enters the filter set 1 via the third port 27.3 of the third valve 7.3. Thereafter, the particularly sterile compressed air is conducted via the second port 27.2 of the third valve 7.3 and the first port 29.1 of the fourth valve 7.4 into the fourth valve 7.4. The particularly sterile compressed air is then conducted via the second port 29.2 of the fourth valve 7.4 and the first port 31.1 of the second fluid filter 3.2 into the second fluid filter 3.2. The particularly sterile compressed air then enters the second valve 7.2 via the second port 31.2 of the second fluid filter 3.2 and the first port 15.1 of the second valve 7.2. Subsequently, the particularly sterile compressed air, in particular together with flushing fluid flushed out of the second fluid filter 3.2 using the sterile compressed air, is conducted out of the filter set 1 via the second port 15.2 of the second valve 7.2. After that, the particularly sterile compressed air is conducted via the second second hose 5.2″ and particularly the second hose 5.2 into the discharge container 21. In particular in the third double filter operating state, the third port 15.3 of the second valve 7.2, the first port 27.1 of the third valve 7.3 and the third port 29.3 of the fourth valve 7.4 are blocked, so that the particularly sterile compressed air can be conducted in the third double filter operating state exclusively through the second fluid filter 3.2 and into the discharge container 21.

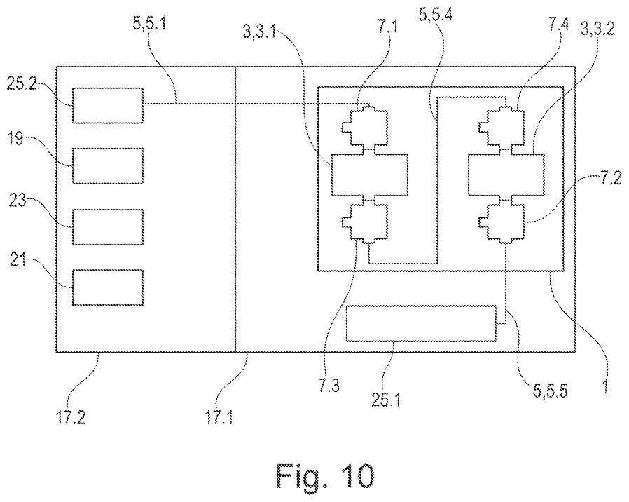

The tenth step j) of the method, in particular a filtration of the product fluid in the filter set 1, is shown in FIG. 10. The first hose 5.1 connects the first port 13.1 of the first valve 7.1 and the second product container 25.2 fluidically to one another.

Furthermore, the first second hose 5.2′ and the second second hose 5.2″ are in particular fluidically separated from the filter set 1. Therefore, the second hose 5.2, the first second hose 5.2′ and the second second hose 5.2″ are not shown in FIG. 10.

In a fourth double filter operating state of filter set 1 in FIG. 10, the first valve 7.1, the second valve 7.2, the third valve 7.3 and the fourth valve 7.4 are set in such a way that the product fluid from the second product container 25.2 is filtered using the first fluid filter 3.1 and the second fluid filter 3.2. In this process, the product fluid enters the filter set 1 via the first port 13.1 of the first valve 7.1. After that, the product fluid is conducted via the second port 13.2 of the first valve 7.1 and the first port 11.1 of the first fluid filter 3.1 into the first fluid filter 3.1. The product fluid then enters the third valve 7.3 via the second port 11.2 of the first fluid filter 3.1 and the first port 27.1 of the third valve 7.3. After that, the product fluid is conducted via the second port 27.2 of the third valve 7.3 and the first port 29.1 of the fourth valve 7.4 into the fourth valve 7.4. The product fluid will then be conducted through the second port 29.2 of the fourth valve 7.4 and the first port 31.1 of the second fluid filter 3.2 into the second fluid filter 3.2. The product fluid then enters the second valve 7.2 via the second port 31.2 of the second fluid filter 3.2 and the first port 15.1 of the second valve 7.2 and is conducted out of the filter set 1 via the third port 15.3 of the second valve 7.2. After that, the product fluid will be conducted into the first product container 25.1 via the fifth hose 5.5. In particular, in the fourth double filter operating state, the third port 13.3 of the first valve 7.1, the second port 15.2 of the second valve 7.2, the third port 27.3 of the third valve 7.3 and the third port 29.3 of the fourth valve 7.4 are blocked, so that in the fourth double filter operating state, after passing through the filter set 3, the product fluid can be conducted exclusively into the first product container 25.1.

The foregoing description of the embodiment has been provided for purposes of illustration and description. It is not intended to be exhaustive or to limit the disclosure.

Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A method for carrying out a filter test, wherein
a) a plurality of hoses is or will be laid from a first clean room of a first, higher clean room class into a second clean room of a second, lower clean room class, wherein a sterile filter set is provided in the first clean room, wherein at least one fluid container, at least one discharge container and a filter test device are provided in the second clean room, wherein
b) at least a first hose of the plurality of hoses is or will be fluidically connected by at least a first end to the sterile filter set, wherein
c) the at least one first hose of the plurality of hoses is or will be fluidically connected by at least one second end to the at least one fluid container, wherein
d) at least one second hose of the plurality of hoses is or will be fluidically connected by at least one first end to the sterile filter set, wherein the at least one second hose of the plurality of hoses opens into the at least one discharge container by at least one second end, wherein
e) the filter set is flushed in that a flushing fluid is conducted from the at least one fluid container through the filter set into the at least one discharge container, wherein
f) after the filter set has been flushed, the second end of the at least one first hose is disconnected from the fluid container and fluidically connected to the filter test device, wherein
g) a filter test is carried out using the filter test device.

2. The method according to claim 1, wherein the steps a) to g), in particular all the steps, are carried out aseptically.

3. The method according to claim 1, wherein the filter set is subjected to compressed air and/or an inert gas after step e) and before step f) in order to at least partially dry the filter set using the compressed air and/or the inert gas.

4. The method according to claim 1, wherein at least one first product container is provided in the first clean room, wherein at least one second product container is provided in the second clean room, wherein
h) the filter set is or will be fluidically connected to the at least one first product container, wherein
i) after the filter test, the second end of the first hose is disconnected fluidically from the filter test device and connected to the at least one second product container, wherein
j) a product fluid is conducted from the second product container through the filter set into the first product container, wherein the product fluid is filtered in the filter set.

5. The method according to claim 1, wherein
the sterile filter set comprises at least one fluid filter, at least three hoses and at least two valves, wherein
in step a) a first port of the at least one fluid filter is or will be fluidically connected to a second port of a first valve of the at least two valves, wherein
in step a), a second port of the at least one fluid filter is or will be fluidically connected to a first port of a second valve of the at least two valves, wherein
in step b), the first end of the first hose is or will be fluidically connected to a first port of the first valve, wherein
in step d) the first end of the second hose is or will be fluidically connected to a second port of the second valve, wherein
in step e), in a first single filter operating state of the filter set, the first valve and the second valve are set in such a way that the at least one fluid filter is flushed with the flushing fluid from the fluid container, wherein the flushing fluid enters the filter set via the first port of the first valve and exits from the filter set via the second port of the second valve, wherein the flushing fluid is conducted via the second hose into the at least one discharge container, wherein
in step g) the first single filter operating state is set in order to carry out the filter test.

6. The method according claim 1, wherein after step e) and before step f) in a second single filter operating state of the filter set, the first valve is set in such a way that compressed air and/or an inert gas enters the filter set via the first port of the first valve and exits the filter set via a third port of the first valve, wherein the compressed air and/or the inert gas is conducted in particular only through the first valve in order to dry the first hose.

7. The method according claim 1, wherein
in step a) or in step h) the third port of the second valve is or will be fluidically connected to a first port of the first product container, wherein
in step j), in a third single filter operating state of the filter set, the first valve and the second valve are set in such a way that the product fluid from the second product container is filtered using the at least one fluid filter, wherein the product fluid enters the filter set via the first port of the first valve and exits the filter set via the third port of the second valve and is conducted into the first product container.

8. The method according to claim 1, wherein before or after step j) the second hose is disconnected fluidically from the filter set and is preferably brought from the first clean room into the second clean room, in particular via at least one duct opening.

9. The method according to-one claim 1, wherein the first clean room is configured as a glove box and, in particular, the fluidic connecting and/or disconnecting of the hoses from the ports is carried out via the gloves of the glove box.

10. The method according to-one claim 1, wherein
the at least one filter set comprises a first fluid filter, a second fluid filter, the first valve, the second valve, a third valve, a fourth valve, the first hose, a first second hose, a second second hose and a third hose, wherein
in step a) a first port of the first fluid filter is or will be fluidically connected to the second port of the first valve, wherein
in step a), a second port of the first fluid filter is or will be fluidically connected to a first port of the third valve,
in step a), the second port of the third valve is or will be fluidically connected to a first port of the fourth valve, wherein
in step a), a first port of the second fluid filter is or will be fluidically connected to a second port of the fourth valve, wherein
in step a), a second port of the second fluid filter is or will be fluidically connected to the first port of the second valve, wherein
in step b) the first end of the first hose is or will be fluidically connected to the first port of the first valve, wherein
in step d), the first end of the first second hose is or will be fluidically connected to a third port of the fourth valve, wherein
in step d), the first end of the second second hose is or will be fluidically connected to the second port of the second valve, wherein
in step e), in a first first double filter operating state of the filter set, the first valve, the second valve, the third valve and the fourth valve are set in such a way that the first fluid filter and the second fluid filter are flushed with the flushing fluid from the fluid container, wherein the flushing fluid enters the filter set via the first port of the first valve and exits the filter set via the second port of the second valve, wherein the flushing fluid is conducted via the second second hose into the at least one discharge container and/or in step e) in a second first double filter operating state of the filter set, the first valve, the second valve, the third valve and the fourth valve are set in such a way that the first fluid filter is flushed with the flushing fluid from the fluid container, wherein the flushing fluid enters the filter set via the first port of the first valve and exits the filter set via the third port of the fourth valve, wherein the flushing fluid is conducted via the first second hose into the at least one discharge container, wherein
in a first sub-step g1) a first end of the third hose is or will be fluidically connected to a third port of the third valve, wherein
in a second sub-step g2), in a second double filter operating state of the filter set, the first valve, the third valve and the fourth valve are set in such a way that the first fluid filter can be tested, wherein in particular sterile compressed air enters the filter set via the first port of the first valve and exits the filter set via the third port of the fourth valve, wherein the second fluid filter is separated fluidically from the filter test device, wherein
in a third sub-step g3), in a third double filter operating state of the filter set, a second end of the third hose is fluidically connected to the filter test device and the second valve, the third valve and the fourth valve are set in such a way that the second fluid filter can be tested, wherein in particular sterile compressed air enters the filter set via the third port of the third valve and exits the filter set via the second port of the second valve, wherein the first fluid filter is fluidically separated from the filter test device.

11. The method according to claim 10, wherein in step e), after the filter set has been flushed in the first first double filter operating state and/or the second first double filter operating state, the second end of the third hose is fluidically connected to the fluid container, wherein in a third first double filter operating state of the filter set, the first valve, the second valve, the third valve and the fourth valve are set in such a way that the second fluid filter is flushed with the flushing fluid from the fluid container, wherein the flushing fluid enters the filter set via the third port of the third valve and exits the filter set via the second port of the second valve, wherein the flushing fluid is conducted via the second second hose into the at least one discharge container.

12. The method according to claim 10, wherein before the first sub-step g1) and/or after the third sub-step g3) the filter set is set in a fourth double filter operating state, wherein the filter set is dried with an inert gas, in particular with nitrogen, wherein in particular the inert gas, in particular nitrogen, enters the filter set via the third port of the third valve and exits the filter set via the third port of the fourth valve, wherein the first fluid filter is fluidically separated from the second fluid filter.

13. The method according to-one claim 10, wherein
in step a) or in step h) the third port of the second valve is or will be fluidically connected to a first port of the first product container, wherein
in step j), in a fourth double filter operating state of the filter set, the first valve, the second valve, the third valve and the fourth valve are set in such a way that the product fluid from the second product container is filtered using the first fluid filter and the second fluid filter, wherein the product fluid enters the filter set via the first port of the first valve and exits the filter set via the third port of the second valve and is conducted into the first product container.

14. A sterile filter set with at least one fluid filter, at least three hoses, at least two valves and instructions for use comprising instructions for carrying out the method according to claim 1.
